(19) United States
(12) Patent Application Publication
(10) Pub. No.: US 2026/0281530 A1
(43) Pub. Date: Sep. 17, 2026

(54) LEAD LENS-TYPE FOLDED ACTUATOR HAVING AF-DRIVEN LIGHT-REFRACTING ELEMENT AND CAMERA INCLUDING ACTUATOR

(71) Applicant: JAHWA ELECTRONICS CO., LTD., Cheongju-si (KR)

(72) Inventors: Dok Hyun KIM, Cheongju-si (KR); Gyu Tae PARK, Cheongju-si (KR); Hyeon Ik CHO, Jeungpyeong-gun (KR)

(73) Assignee: JAHWA ELECTRONICS CO., LTD., Cheongju-si (KR)

(21) Appl. No.: 19/678,759

(22) Filed: May 15, 2026

Related U.S. Application Data
(63) Continuation of application No. PCT/KR2024/014227, filed on Sep. 20, 2024.

(30) Foreign Application Priority Data
Nov. 15, 2023 (KR) 10-2023-0158672

(51) Int. Cl. H04N 23/55; G03B 3/10; G03B 5/02; G03B 17/12; G03B 17/17; G03B 30/00; H04N 23/68

(52) U.S. Cl. CPC H04N 23/55; G03B 3/10; G03B 5/02; G03B 17/12; G03B 17/17; G03B 30/00; H04N 23/6811; H04N 23/683; H04N 23/687; G03B 2205/0015; G03B 2205/0069

(57) ABSTRACT

A lead lens-type folded actuator in which a light-refracting element is AF-driven, and to a camera equipped with the actuator. The actuator includes a box body including a base and a case and having an inner space. The upper surface of the box body has a through-portion through which incident light from a subject is incident, and the side surface of the box body is provided with a light-emitting part. In the inner space of the box body, a light-refracting AF module, an OIS module, and a lens module, which is inserted into a through-portion formed in the center of an IS module, are arranged in this order from the bottom. The light-refracting AF module includes a light-refracting element, and light emitted from the lens module is incident and refracted by the light-refracting element and is then emitted in a first direction toward the light-emitting part.

### TECHNICAL FIELD

The present invention relates to a lead lens-type folded actuator in which a light-refracting element is AF-driven, and to a camera equipped with the actuator.

### BACKGROUND

Performance of a smartphone camera is developing day by day, and a trend is that a camera lens having a lower f-number is being adopted. For example, in the case of a Samsung Galaxy S23 model recently released, three cameras are mounted on the rear and one camera is mounted on the front, in which cameras having f 1.8, f 2.2, and f 2.4 values, respectively, are mounted on the rear, and a camera having an f 2.2 value is mounted on the front. Among these, the camera having the f 1.8 value allows a bright photo to be captured even in a dark situation, and also allows a certain level of out-focus effect to be expected.

In the case of an Apple iphone 14 model compared thereto, two cameras on the rear and one camera on the front are mounted, and cameras having f 1.5 and f 2.4 values, respectively, are on the rear, and a camera having an f 1.9 value is on the front, so that a lens having the lowest f-value is f 1.5, which is even lower than f 1.8 of the Samsung Galaxy S23 model, and thus it can be seen that the product is more advantageous during night shooting.

A product with a low f-value can provide a bright and clear shooting result during night shooting, and when the f-number is as low as about f 1.2 to f 1.5, a depth of field is shallow so that a subject stands out and a photo with a soft background can be obtained during daytime shooting, and thus it can be particularly utilized a lot for a portrait. On the other hand, a case where the f-number is as high as about f 2.4 is one used for most photos, and a photo obtained under a high f-number condition allows more subjects located at various distances to be focused.

Meanwhile, a folded-type camera is being released, which has a great advantage in slimming a thickness of a smartphone, that is, a folded camera having a structure that refracts light of a subject incident perpendicularly to a plane forming a camera body by 90 degrees, propagates the light in a horizontal direction of the camera body, and disposes an image sensor at a position where the propagated light reaches.

The folded camera structure is well illustrated, for example, in drawings of Korean Patent Publication No. 2021-0035516 (published on Apr. 1, 2021).

A conventional typical folded camera as illustrated in FIG. 1 is configured with a light-refracting element (folding element), a lens module, and an image sensor, and the light-refracting element changes a propagating path of incident light incident in a thickness direction of a mobile device to a direction perpendicular to the thickness direction of the mobile device, for example, a width or length direction of a smartphone. The light-refracting element includes a prism body, and the lens module includes a plurality of lenses for forming an image, and if necessary, an aperture may be included. Also, the lens module may be moved by an actuator, and through this, an optical zoom may be implemented.

The conventional folded camera generally adopts a structure in which incident light is first refracted by 90 degrees by the light-refracting element as described above, and then the refracted and emitted light is focused by the lens module to acquire an image from the image sensor, and such the structure is desirable in terms of being able to implement a thickness of the smartphone to be thin, but there is a problem that it is inconsistent with a current trend of trying to develop a low f-number camera.

That is, since the conventional folded-type camera does not have a lens at a front end of the light-refracting element (prism or mirror), there is a problem that it is difficult to secure a bright image, that is, the f-number is high.

Accordingly, development of a camera lens product to achieve a lower f-number by disposing a lens group in front of the light-refracting element is being sought as a more recent technology.

However, in the case of a structure in which the lens group is disposed in front of the light-refracting element as described above (hereinafter, such the structure is referred to as a “lead lens”), various problems are encountered in actual design regarding how an optical image stabilization (hereinafter, abbreviated as “OIS”) technology and an auto focusing (hereinafter, abbreviated as “AF”) technology can be applied.

That is, when designing with a lead lens structure for a low f-number, if AF technology is applied to the lead lens, a problem occurs in which a camera lens part protrudes in the thickness direction of the smartphone or more space capable of moving back and forth in the thickness direction of the smartphone is required, so that slimming of the smartphone cannot be fully implemented; and if OIS technology is designed and controlled in a form of rotating the light-refracting element as in Korean Patent Publication No. 2022-0108526, a problem occurs in which a package design is very difficult due to complex design elements, and a manufacturing cost, etc. rise.

Also, a design plan implementing AF by moving together an assembly in which the lead lens and the light-refracting element are coupled in a direction parallel to an optical axis incident on the image sensor may be considered, but when moving the light-refracting element and the lead lens in a horizontal direction as described above, it is seen that the lens moves in the horizontal direction during a camera operation, which may become a factor causing consumers to have doubts about durability or stability of a product, and may be a cause of lowering satisfaction with product quality.

### DOCUMENTS OF RELATED ART

(Patent Document 1) KR 10-2021-0035516 A (Apr. 1, 2021)
(Patent Document 2) KR 10-2022-0108526 A (Aug. 3, 2022)

### SUMMARY

In order to solve the problems of the related art, the present invention is directed to providing a lead lens-type folded actuator of a completely new configuration that cannot be found in the related art, and a camera equipped with this actuator, by applying a technology for correcting hand-shake by moving a lens group itself in a horizontal direction on a plane perpendicular to an optical axis direction to a lead lens, while not applying an AF function to the lead lens, and applying a technology for moving only a light-refracting element in the optical axis direction for AF.

One embodiment of the present invention is directed to providing a folded actuator in which the AF function is implemented by moving the light-refracting element in an optical axis direction of a light-emitting part of the actuator, while an OIS function is smoothly performed while a low f-number is implemented, by having a configuration of driving the lead lens with an actuator capable of moving in the horizontal direction on the plane perpendicular to an incident optical axis for the OIS function.

Another problem to be solved by the present invention is for providing a camera equipped with such the folded actuator.

Also, in applying the folded actuator of the present invention to the camera, the present invention is directed to providing a control for canceling movement of an image according to movement of the light-refracting element.

As a technical solution for achieving the aforementioned objects, the present invention provides a lead lens-type folded actuator in which a light-refracting element is AF-driven, comprising: a box body comprising a base at a lower part and a case at an upper part forming an inner space, and having a through-portion through which incident light from a subject is incident formed on an upper surface thereof and a light-emitting part formed on a side surface thereof;
a light-refracting AF module received in the inner space of the box body and comprising a light-refracting element; and
an OIS module received in the inner space of the box body and comprising a lens module located between the light-refracting AF module and the subject,
wherein the lens module emits the incident light from the subject toward the light-refracting AF module as emitted light having a focal length,
the light-refracting element of the light-refracting AF module refracts the emitted light of the lens module and emits the same in a first direction toward the light-emitting part,
the light-refracting AF module moves relative to the base in the first direction and is autofocusing-driven to change a focus of the emitted light emitted from the lens module, and
wherein the OIS module is OIS-driven in the first direction and a second direction perpendicular to the first direction on a plane perpendicular to the incident light incident on the lens module to slightly move the lens module in the first direction and the second direction.

Here, the light-refracting AF module may comprise the light-refracting element and an AF carrier, and the light-refracting element may be a right-angled triangular prism or a reflecting mirror capable of refracting the incident light incident on the lens module from the subject toward the light-emitting part.

In addition, an AF driving magnet may be attached to a bottom surface part of the AF carrier, and an AF driving coil may be inserted into a bottom surface part of the base facing the AF carrier.

Further, AF moving-side ball rails may be formed in the first direction, which is an AF driving direction, on bottom surface parts of left and right sides in a width direction of the AF carrier, AF fixed-side ball rails may be formed in the first direction on an upper surface of a bottom part of left and right sides in the width direction of the base, and AF guide balls may be inserted between the AF moving-side ball rails of the AF carrier and the AF fixed-side ball rails of the base so that movement of the AF guide balls is guided during AF driving.

The OIS module according to one aspect of the present invention may comprise a first OIS carrier which is OIS-driven in the second direction relative to the base, and a second OIS carrier which is OIS-driven in the first direction relative to the first OIS carrier.

In addition, the first OIS carrier and the second OIS carrier may have a shape formed by an outline of a quadrangle when viewed from above, and a circular through-portion into which the lens module is inserted may be formed in the center, and first OIS moving-side ball rails may be formed in the second direction at each corner part of a bottom surface of the first OIS carrier.

In addition, second OIS fixed-side ball rails may be formed in the first direction at each corner part of an upper surface of the first OIS carrier, second OIS moving-side ball rails may be formed in the first direction at each corner part of a bottom surface of the second OIS carrier, and a second OIS guide ball may be inserted between the first OIS carrier and the second OIS carrier, so that the second OIS guide ball is guided in the first direction during an OIS driving of the OIS module in the first direction.

Further, a first OIS magnet may be mounted on a side surface facing a first OIS driving coil of the base, among side surfaces of the second OIS carrier, and a second OIS magnet may be mounted on a side surface facing a second OIS driving coil of the base, among the side surfaces of the second OIS carrier.

The base according to an aspect of the present invention is also an enclosure with an open upper part, and a light-passing part is formed through a front side thereof, and the first OIS driving coil may be inserted into an upper part of a side surface of the base, and the second OIS driving coil may be inserted into an upper part of another side surface thereof.

In addition, the light-refracting AF module is disposed in a lower space and the OIS module is disposed in an upper space based on an upper surface of a stepped part formed at a predetermined intermediate height of the base.

Further, a first OIS fixed-side ball rail may be formed in the second direction on the upper surface of the stepped part of the base.

In addition, a first OIS guide ball may be inserted between the base and the OIS module, so that the first OIS guide ball is guided in the second direction during an OIS driving of the OIS module in the second direction.

As a technical solution for solving the problems, according to another aspect of the present invention, there is provided a camera module, comprising: the lead lens-type folded actuator in which a light-refracting element is AF-driven according to the aforementioned aspect; and

an image sensor module disposed adjacent to a light-emitting part of the lead lens-type folded actuator in which the light-refracting element is AF-driven, and configured to receive light having passed through the lead lens-type folded actuator in which the light-refracting element is AF-driven, to output image information corresponding to the received light.

In addition, the camera module outputs a captured image by moving an image in the image sensor module or the image sensor module itself by a positional change of an optical axis according to AF driving of the light-refracting AF module.

Further, in a case of moving the image in the image sensor module, a pixel movement amount in the image sensor module may be calculated based on a signal for AF driving of the light-refracting AF module, and the image may be moved and displayed according to the pixel movement amount, thereby canceling a movement amount of a screen due to the AF driving of the light-refracting AF module.

In addition, in a case of moving the image sensor module itself, a movement amount of the image sensor module may be calculated based on a signal for AF driving of the light-refracting AF module, and by moving the image sensor module, a movement amount of a focus of a subject due to the AF driving of the light-refracting AF module may be canceled.

According to one embodiment of the present invention, a lens module is disposed at the foremost position so that incident light from a subject incident into an actuator is met first, and an OIS function is driven in a space corresponding to a height of a lens group, whereby not only can a low f-number be secured, but also OIS implementation is possible in a minimum package space, and also an effect of not requiring an AF driving space in an actuator height direction is achieved by implementing an AF function by driving a light-refracting AF module in an actuator light-emitting part direction.

In particular, since a complex structure for rotating a light-refracting element for OIS driving as in the related art does not have to be applied, difficulties in package design can be overcome, and also a manufacturing cost can be lowered.

Also, since it has a configuration in which a lens does not move in a horizontal direction during a camera operation, a problem of the related art in which the lens moves in the horizontal direction to potentially cause consumers to have doubts about durability or stability of a product is resolved, so that an effect of increasing satisfaction with product quality can be brought.

### BRIEF DESCRIPTION OF DRAWINGS

FIG. 1 is a configuration diagram of a folded camera of the related art.

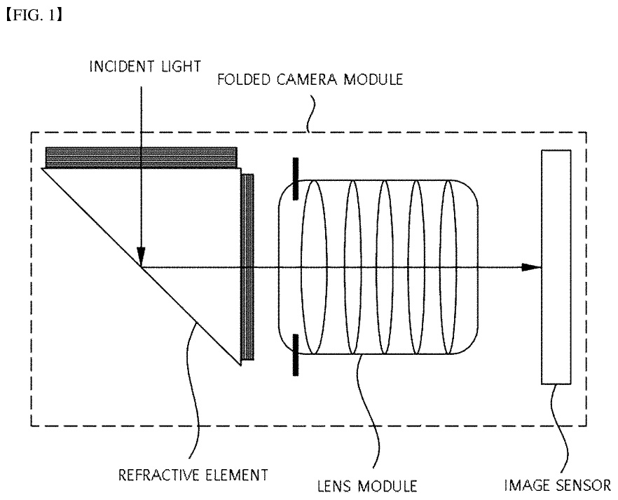

FIG. 2 is an assembled perspective view of a folded actuator and a view illustrating a coupling relationship between the folded actuator and an image sensor module according to one embodiment of the present invention.

FIG. 3 is a partially exploded perspective view of the folded actuator illustrated in FIG. 2.

FIG. 4 is an overall exploded perspective view of the folded actuator illustrated in FIG. 3.

FIG. 5 is an overall exploded perspective view of the folded actuator illustrated in FIG. 4 viewed from below.

FIG. 6 is a cutaway perspective view of a base illustrated in FIG. 3 and FIG. 4 viewed by removing a side wall of the base so that an inside of the base is seen.

FIG. 7 is a cross-sectional view of the folded actuator illustrated in (a) of FIG. 2 viewed from a line A-A direction.

FIG. 8 is a conceptual view illustrating a change in a focal length during AF driving by schematically illustrating a cross-sectional configuration of FIG. 7.

### DETAILED DESCRIPTION

Hereinafter, exemplary embodiments of the present invention will be described in detail. Prior to this, it is clarified that terms or words used in the present specification and the claims shall not be construed as being limited only to dictionary definitions, and based on the principle that an inventor may appropriately define the concept of a term to best describe his or her own invention, they shall be construed in the meaning and concept conforming to the technical teachings of the present invention.

Accordingly, it should be understood that the embodiment described in the present specification and the configuration illustrated in the drawings are merely one most preferred embodiment, and are not intended to represent all of the technical teachings of the present invention, and that, at the time of filing the present application, various equivalents and modified examples capable of substituting the embodiments may be made.

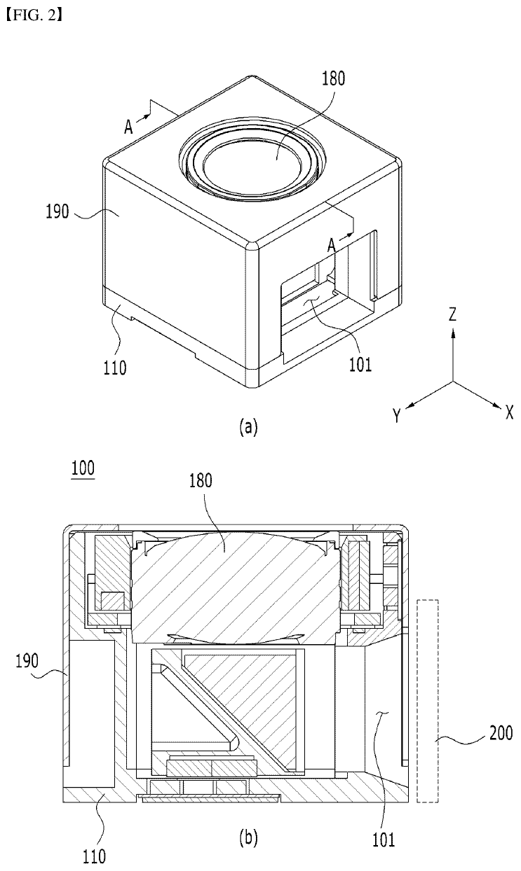

Hereinafter, the overall configuration of the actuator of the present invention and a coupling relationship with an image sensor module 200 will be first described with reference to FIG. 2, and a detailed description of an embodiment of the present invention implementing each function of AF and OIS will be provided later.
(a) of FIG. 2 is an assembled perspective view of a folded actuator (hereinafter, referred to as an “actuator”) according to one embodiment of the present invention, and (b) of FIG. 2 is a view illustrating a coupling relationship between the actuator 100 and the image sensor module 200 according to the present invention.

A-Z-axis direction illustrated in FIG. 2 is an incident optical axis direction which is a direction in which light is incident on a lens module 180, and an X-axis direction and a Y-axis direction, which are two directions perpendicular to the incident optical axis direction (−Z-axis direction), are directions in which an OIS module 170 moves by OIS driving so that shaking of the incident optical axis due to hand-shake during shooting is compensated, and in the following description, the X-axis direction is referred to as a first direction and the Y-axis direction is referred to as a second direction, but this is only an example, and it goes without saying that any one direction of the X-axis direction and the Y-axis direction may be the first direction, and the other direction may be the second direction. Also, in describing the actuator of the present invention, a +X-axis direction is expressed as front and a-X-axis direction is expressed as rear, and a front-rear direction means the X-axis direction which is the first direction, and in this case, a part where a light-emitting part 101 of the actuator illustrated in FIG. 2 is located may be referred to as a front part, and in the present invention, a width direction means directions toward left and right sides when viewed from the light-emitting part 101 side as the Y-axis direction.

The actuator 100 of the present invention illustrated in (a) of FIG. 2 is configured with a base 110 constituting a bottom part and a case 190 covering thereabove to form a box body of substantially a hexahedron, and a circular through-portion through which incident light from a subject is incident on the lens module 180 is formed on an upper surface of the case 190, and more preferably, the circular through-portion may be larger than a diameter of the lens module 180 by an OIS driving stroke size so that incident light incident on the lens module 180 is not blocked during OIS driving in the first direction and the second direction of the OIS module.

Next, a light-emitting part 101 of substantially a quadrangle formed by a L-shaped through-portion on one side surface of the case 190 and a bottom surface of a side through-portion formed in the base is provided so that incident light from the subject can reach the image sensor module 200 in a state of being refracted by a light-refracting element 120 inside the actuator, and as illustrated in (b) of FIG. 2, the image sensor module 200 is disposed adjacent to the light-emitting part 101 on a plane perpendicular to an optical axis direction of the light-emitting part, so that a camera may be implemented.

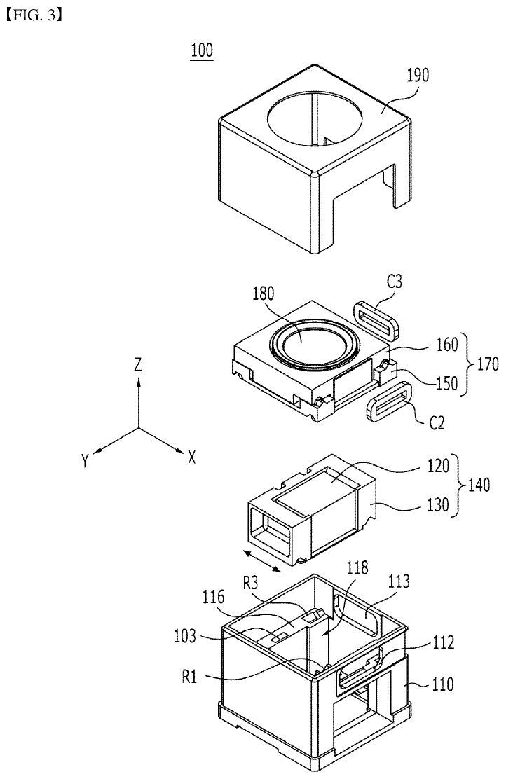

Next, FIG. 3 is a partially exploded perspective view of the actuator of the present invention illustrated in FIG. 2, and in the actuator of the present invention, a light-refracting AF module 140, an OIS module 170, and a lens module 180 are disposed in this order from the bottom in an inner space formed by coupling the base 110 and the case 190, and the light-refracting AF module 140 is disposed in a lower space based on a plane of a stepped part formed at a predetermined intermediate height of the base 110, and the OIS module 170 is disposed above the plane of the stepped part. Further, the light-refracting AF module 140 is driven in the first direction (X-axis direction) relative to the base 110, and the OIS module 170 includes a coil, a magnet, etc. so that the lens module 180 is driven in the first direction (X-axis direction) and the Y-axis direction.

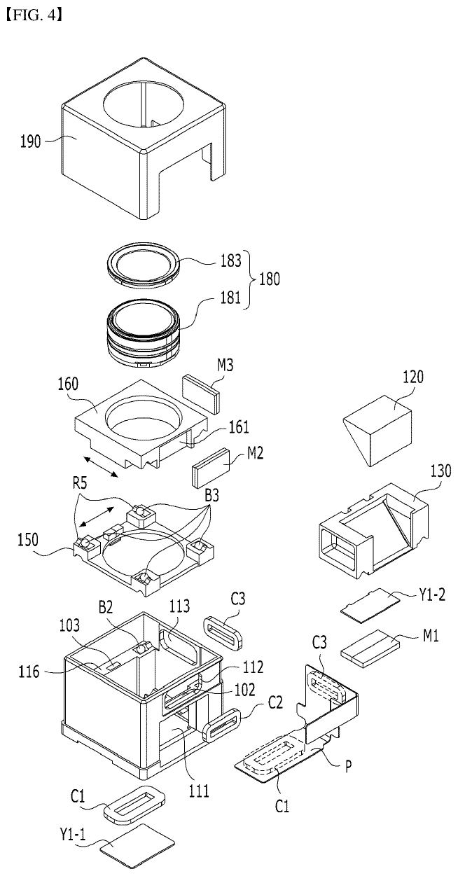

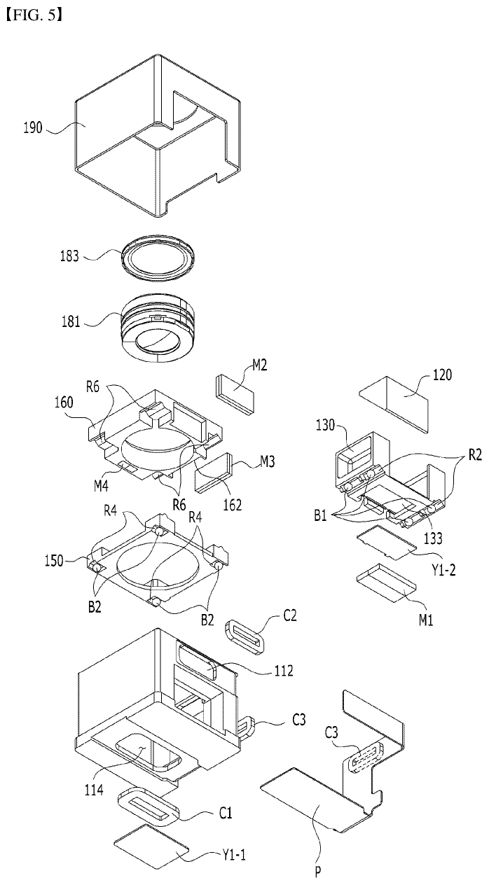

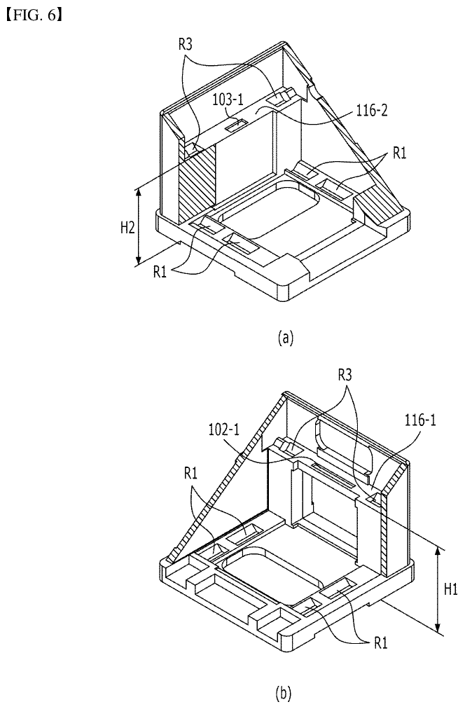

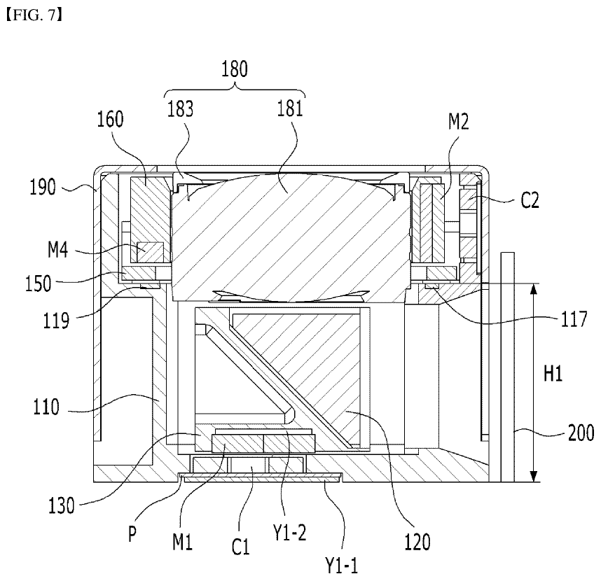

FIG. 4 and FIG. 5 are overall exploded perspective views of the folded actuator illustrated in FIG. 3, which are perspective views viewed from the top and bottom, respectively, and illustrate detailed all configurations of the AF module, the OIS module 170, and the lens module 180 in an exploded state, and FIG. 7 is a cross-sectional view taken along an A-A plane illustrated in FIG. 2 (a), and FIG. 6 is a cutaway perspective view of the base 110 illustrated in FIG. 3 and FIG. 4 viewed by removing a side wall of the base 110 so that an inside of the base 110 is seen.

Looking with reference to these drawings, the base 110 constituting the folded actuator of the present invention is an enclosure of substantially a hexahedron with an open upper part, and a quadrangular light-passing part 111 is formed through a front side thereof, and a first OIS driving coil mounting part (112) into which a first OIS driving coil is inserted is formed at an upper part of the light-passing part, and a second OIS driving coil mounting part (113) into which a second OIS driving coil C3 is inserted is formed at an upper part of a side surface of the base 110. The embodiment illustrated in the drawings shows only that the first OIS driving coil mounting part (112) is disposed on a front surface of the base 110, but it goes without saying that the first OIS driving coil mounting part may be disposed on a rear surface of the base 110, and the second OIS driving coil mounting part (113) is also provided on the right side when viewed from the front of the base 110, but it goes without saying that it may be provided on the left side of the base 110.

In addition, if necessary, in the actuator of the present invention, one OIS driving coil each may be disposed at the front and rear of the base 110, and one OIS driving coil each may be disposed at the left and right, and since the number of driving coils can be variously applied to the front, rear, left, and right as necessary, correspondingly, coil mounting parts may be formed in various ways to the front, rear, left, and right on the base 110, for example, one each at the front and rear and one only on the right side, or one at the rear and one each on the left and right sides.

Also, on a bottom surface part of the base 110, an AF coil mounting part 114 into which an AF driving coil C1 is inserted is provided as illustrated in FIG. 5, and more preferably, a groove part of a predetermined depth in a width direction or a front-rear direction of the base bottom surface part may be formed on the bottom surface part of the base 110 as illustrated in the drawings so as to allow the AF driving coil to be seated on the AF coil mounting part 114 in a state of being electrically connected to a flexible PCB P on which a printed circuit is formed, and more preferably, an AF fixed-side yoke Y1-1 is attached to an outside of the flexible PCB P so that electromagnetic force of the AF driving coil C1 can be effectively transmitted to an AF magnet M1 and an AF moving-side yoke Y1-2.

Further, on an inside of the base 110, as illustrated in (a) and (b) of FIG. 6, on an upper surface of the bottom part of the base 110, AF fixed-side ball rails R1 capable of guiding AF guide balls B1, which will be described later, in the first direction are formed on left and right sides in the width direction, and on an upper surface of the stepped part 116 located at a predetermined height H of the base 110, a first OIS fixed-side ball rail R3 capable of guiding first OIS guide balls B2, which will be described later, in the second direction is formed.

Next, the light-refracting AF module 140 constituting the folded actuator of the present invention, as illustrated in FIG. 2, FIG. 3, and FIG. 4, is configured with a light-refracting element 120 having a shape of a cross-section using a plane formed by an incident optical axis (−Z-axis) and an exit optical axis (X-axis) as a cutting plane of substantially a right triangle, and an AF carrier 130 of a rectangular parallelepiped shape in which an inclined surface part where an inclined surface of this light-refracting element is seated is recessed to one side.

Further, an AF driving magnet M1 is attached to a bottom surface part of the AF carrier 130, and on the AF carrier bottom surface part at a position where the AF driving magnet M1 is attached, it is preferable that an AF carrier bottom surface recessed part 133 recessed by a depth corresponding to a thickness of the AF driving magnet is formed as illustrated in FIG. 5, and an AF moving-side yoke Y1-2 may be attached between the AF driving magnet and the bottom surface part of the AF carrier.

Also, on bottom surface parts of left and right sides in the width direction of the AF carrier 130, AF moving-side ball rails R2 guiding movement of the AF guide balls B1 during AF driving are formed in the first direction which is an AF driving direction, and it is preferable that four ball rails are formed so as to guide four AF guide balls B1.

In addition, as described above, on the upper surface of the bottom part of the base 110 facing the bottom surface part of the AF carrier, AF fixed-side ball rails R1 guiding the AF guide balls B1 in the AF driving direction are formed in the AF driving direction as illustrated in FIG. 6, and similarly to four AF moving-side ball rails R2 of the AF carrier, it is preferable that four AF fixed-side ball rails R1 are also formed.

By the configuration as described above, the light-refracting AF module 140 of the present invention is driven in the first direction relative to the base 110, so that auto focusing is performed.

Next, the OIS module 170 constituting the folded actuator of the present invention, as illustrated in FIG. 4 and FIG. 5, is configured with a first OIS carrier 150 which is OIS-driven in a second direction relative to the base 110, and a second OIS carrier 160 which is OIS-driven in a first direction relative to the first OIS carrier 150.

The first OIS carrier 150 and the second OIS carrier 160 have a shape formed by an outline of a quadrangle when viewed from the top, and a circular through-portion into which the lens module 180 is inserted is formed in the center.

Also, at each corner part of a bottom surface of the first OIS carrier 150, a first OIS moving-side ball rail R4 guiding the first OIS guide balls B2 in the second direction during OIS driving in the second direction is formed in the second direction, and at each corner part of an upper surface of the first OIS carrier 150, a second OIS fixed-side ball rail R5 guiding second OIS guide balls B3 in the first direction during OIS driving in the first direction is formed in the first direction.

Next, at each corner part of a bottom surface of the second OIS carrier 160, a second OIS moving-side ball rail R6 guiding the second OIS guide balls B3 in the first direction during OIS driving in the first direction is formed in the first direction, and a first OIS magnet mounting part 161 where a first OIS magnet is mounted may be formed on a side surface facing the first OIS driving coil mounting part 112 of the base 110, among side surfaces of the second OIS carrier 160, and a second OIS magnet mounting part 162 where a second OIS magnet M3 is mounted may be formed on a side surface facing the second OIS driving coil mounting part 113 of the base 110, among side surfaces of the second OIS carrier 160.

Further, the first OIS magnet M2 and the second OIS magnet M3 are attached to the first OIS magnet mounting part 161 and the second OIS magnet mounting part 162, respectively.

Next, the lens module 180 inserted into the circular through-portion of the second OIS carrier 160 may be configured with a lens group 181 and a lens bezel ring 183, where the lens group may be a configuration in which lenses are inserted into a cylinder-shaped barrel part, and the lens bezel ring 183 may be a configuration attached to or coupled to an outer peripheral surface or an inner peripheral surface, or the outer peripheral surface and the inner peripheral surface of the barrel part.

In addition, PCB circuits may be respectively provided to apply driving power of an appropriate magnitude and direction to the AF driving coil C1, the first OIS driving coil C2, and the second OIS driving coil C3, and preferably, as illustrated in FIG. 4 and FIG. 5, it may be configured with a single flexible PCB P capable of controlling all three coils.

Through the configuration as described above, in the OIS module 170 of the present invention, when current according to a control command of a control part (not illustrated) is applied to the second OIS driving coil C3, attractive force or repulsive force is generated by interaction with the second OIS magnet M3 disposed on the side surface of the second OIS carrier 160. In this case, since movement in the second direction of the second OIS guide balls B3 placed between the first OIS carrier 150 and the second OIS carrier 160 is constrained by the second OIS fixed-side ball rail R5, the first OIS carrier 150 and the second OIS carrier 160 become integrated during shaking driving in the second direction, and as a result, via the first OIS guide balls B2 placed between the first OIS moving-side ball rail formed in the second direction located on the lowermost surface of the integrated first OIS carrier 150 and second OIS carrier 160 and the first OIS fixed-side ball rail formed in the second direction located on the upper surface of the stepped part of the base 110, OIS shaking driving in the second direction of the first OIS carrier 150 and the second OIS carrier 160 is performed.

Next, in the OIS module 170 of the present invention, when current according to a control command of a control part (not illustrated) is applied to the first OIS driving coil C2, attractive force or repulsive force is generated by interaction with the first OIS magnet M2 disposed on the side surface of the second OIS carrier 160, and at this time, the second OIS carrier 160 performs OIS shaking driving in the first direction relative to the first OIS carrier 150 through the second OIS guide balls B3 placed between the second OIS fixed-side ball rail R5 located on the upper surface of the first OIS carrier 150 and the second OIS moving-side ball rail R6 located on the bottom surface of the second OIS carrier 160.

The embodiment of the present invention described above is for a case where the first OIS carrier 150 moves relative to the base 110 in the second direction, and the second OIS carrier 160 moves relative to the first OIS carrier 150 in the first direction, but if necessary, it is apparently possible that the OIS function is implemented by the first OIS carrier 150 moving relative to the base 110 in the first direction, and the second OIS carrier 160 moving relative to the first OIS carrier 150 in the second direction.

In addition, as illustrated in FIG. 6, the stepped part 116 may be configured with a front-side stepped part 116-1 having a height H1 at the actuator front side and a rear-side stepped part 116-2 having a height H2 at the rear side, and the heights of H1 and H2 may be made the same.

Also, a first iron piece groove 102-1 into which a first iron piece 102 can be inserted may be formed in the front-side stepped part 116-1, and a second iron piece groove 103-1 into which a second iron piece 103 can be inserted may be formed in the rear-side stepped part 116-2, so that the first iron piece 102 and the second iron piece 103 can be attached.

As illustrated in FIG. 7, the first iron piece 102 and the second iron piece 103 are such that the first iron piece 102 exerts attractive force by interacting with the first OIS magnet M2 attached to the side surface of the second OIS carrier 160 of the OIS module 170, and the second iron piece 103 exerts attractive force with an OIS module magnet M4 attached to the bottom surface of the second OIS carrier 160 of the OIS module 170, whereby attractive force between the OIS module 170 and the base 110 is maintained, so that the OIS module 170 and the base 110 are not separated even when the upper and lower surfaces of the actuator are turned over.

Next, FIG. 7 is a cross-sectional view of a camera module including the actuator according to one side described above. The camera module, which is one embodiment of the present invention, is largely configured to include a lead lens-type folded actuator in which a light-refracting element is autofocusing (AF)-driven, and an image sensor module which is disposed adjacent to a light-emitting part of this actuator, receives light having passed through the lead lens-type folded actuator in which the light-refracting element is AF-driven, and outputs image information corresponding to the received light.

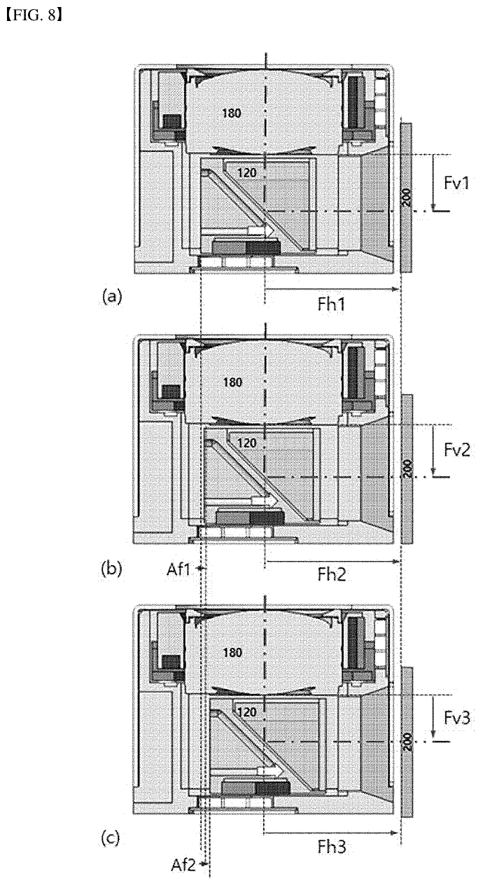

Next, (a), (b), and (c) of FIG. 8 illustrate a camera configured with the lead lens-type folded actuator in which the light-refracting element of the present invention is AF-driven and the image sensor module, and (b) of FIG. 8 illustrates that the light-refracting AF module 140 has moved by Af1 in a direction in which the image sensor module is placed, that is, the first direction, and (c) of FIG. 8 illustrates that the light-refracting AF module 140 has again moved by Af2 in the direction in which the image sensor module is placed, that is, the first direction, from the position of (b).

When the light-refracting AF module 140 moves in the first direction in this way, a path of light incident on and emitted from the lens module 180 is refracted as illustrated in the drawing at the light-refracting element moved in the first direction, and at this time, Fh1, Fh2, and Fh3 values representing distances from a point where the light is refracted at the light-refracting element to a point where it reaches a front surface of the image sensor module always show constant values, whereas distances Fv1, Fv2, and Fv3 connecting a point where the light is emitted from the lens module 180 and the point where it is refracted at the light-refracting element gradually become shorter as the light-refracting AF module 140 moves.

Consequently, a moving distance of light from being incident from the lens module 180 until reaching the image sensor module (this corresponds to a focal length of the lens module) gradually becomes shorter as the light-refracting AF module 140 is moved toward the image sensor module, and this results in a focusing distance becoming shorter. That is, a variation in the focusing distance occurs due to movement of the light-refracting AF module 140, and through this, when a signal for auto focusing is applied to the light-refracting AF module 140, an auto focusing function can be implemented.

However, when the light-refracting AF module 140 is operated in this way, since an optical axis of an image formed by the lens module 180 varies from an initial Fv1 position to an Fv2 position, and again from the Fv2 position to an Fv3 position as illustrated in FIG. 8, it is necessary to display a captured image by moving the image in the image sensor module or the image sensor module itself by a positional change of the optical axis according to AF driving of the light-refracting AF module 140.

In this case, in a case of moving the image in the image sensor module, a pixel movement amount in the image sensor module is calculated based on the signal for AF driving of the light-refracting AF module 140, and the image is moved and displayed according to the pixel movement amount, whereby the movement amount of pixel data due to the AF driving of the light-refracting AF module 140 can be canceled.

Also, more preferably, a process of storing the pixel movement amount according to a control code during AF driving, and checking and storing the pixel movement amount during an AF driving calibration operation may be additionally applied.

As another embodiment, in a case of moving the image sensor module itself, a movement amount of the image sensor module is calculated based on the signal for AF driving of the light-refracting AF module 140, and by moving the image sensor module using a coil and a magnet which are separately configured although not illustrated in the drawing, the movement amount of the optical axis due to the AF driving of the light-refracting AF module 140 may be canceled.

### DESCRIPTION OF REFERENCE NUMERALS

100: Folded actuator
101: Light-emitting part
102: First iron piece
103: Second iron piece
110: Base
111: Light-passing part
112: First OIS driving coil mounting part
113: Second OIS driving coil mounting part
114: AF coil mounting part
116: Stepped part
116-1: Front-side stepped part
116-2: Rear-side stepped part
120: Light-refracting element
130: AF carrier
133: AF carrier bottom surface recessed part
140: Light-refracting AF module
150: First OIS carrier
160: Second OIS carrier
161: First OIS magnet mounting part
162: Second OIS magnet mounting part
170: OIS module
180: Lens module
181: Lens group
183: Lens bezel ring
190: Case
200: Image sensor module
B1: AF guide ball
B2: First OIS guide ball
B3: Second OIS guide ball
C1: AF driving coil
C2: First OIS driving coil
C3: Second OIS driving coil
M1: AF magnet
M2: First OIS magnet
M3: Second OIS magnet
M4: OIS module magnet
R1: AF fixed-side ball rail
R2: AF moving-side ball rail
R3: First OIS fixed-side ball rail
R4: First OIS moving-side ball rail
R5: Second OIS fixed-side ball rail
R6: Second OIS moving-side ball rail
Y1-1: AF fixed-side yoke
Y1-2: AF moving-side yoke

1. A lead lens-type folded actuator in which a light-refracting element is AF-driven, comprising:
a box body comprising a base at a lower part and a case at an upper part forming an inner space, and having a through-portion through which incident light from a subject is incident formed on an upper surface thereof and a light-emitting part formed on a side surface thereof;
a light-refracting auto focusing (AF) module received in the inner space of the box body and comprising a light-refracting element; and
an optical image stabilization OIS module received in the inner space of the box body and comprising a lens module located between the light-refracting AF module and the subject,
wherein the lens module emits the incident light from the subject toward the light-refracting AF module as emitted light having a focal length,
wherein the light-refracting element of the light-refracting AF module refracts the emitted light of the lens module and emits the same in a first direction toward the light-emitting part,
wherein the light-refracting AF module moves relative to the base in the first direction and is autofocusing-driven to change a focus of the emitted light emitted from the lens module, and
wherein the OIS module is OIS-driven in the first direction and a second direction perpendicular to the first direction on a plane perpendicular to the incident light incident on the lens module to slightly move the lens module in the first direction and the second direction.

2. The lead lens-type folded actuator of claim 1, wherein the light-refracting AF module comprises the light-refracting element and an AF carrier, and the light-refracting element is a right-angled triangular prism or a reflecting mirror capable of refracting the incident light incident on the lens module from the subject toward the light-emitting part.

3. The lead lens-type folded actuator of claim 2, wherein an AF driving magnet is attached to a bottom surface part of the AF carrier, and an AF driving coil is inserted into a bottom surface part of the base facing the AF carrier.

4. The lead lens-type folded actuator of claim 3, wherein AF moving-side ball rails are formed in the first direction, which is an AF driving direction, on bottom surface parts of left and right sides in a width direction of the AF carrier, AF fixed-side ball rails are formed in the first direction on an upper surface of a bottom part of left and right sides in the width direction of the base, and AF guide balls are inserted between the AF moving-side ball rails of the AF carrier and the AF fixed-side ball rails of the base so that movement of the AF guide balls is guided during AF driving.

5. The lead lens-type folded actuator of claim 1, wherein the OIS module comprises a first OIS carrier which is OIS-driven in the second direction relative to the base, and a second OIS carrier which is OIS-driven in the first direction relative to the first OIS carrier.

6. The lead lens-type folded actuator of claim 1, wherein the light-refracting AF module is disposed in a lower space and the OIS module is disposed in an upper space based on an upper surface of a stepped part formed at a predetermined intermediate height of the base.

7. The lead lens-type folded actuator of claim 6, wherein a first OIS fixed-side ball rail is formed in the second direction on the upper surface of the stepped part of the base.

8. The lead lens-type folded actuator of claim 1, wherein a first OIS guide ball is inserted between the base and the OIS module, and the first OIS guide ball is guided in the second direction during OIS driving of the OIS module in the second direction.

9. A camera module, comprising:
the lead lens-type folded actuator in which a light-refracting element is AF-driven described in claim 1; and
an image sensor module disposed adjacent to a light-emitting part of the lead lens-type folded actuator in which the light-refracting element is AF-driven, and configured to receive light having passed through the lead lens-type folded actuator in which the light-refracting element is AF-driven, to output image information corresponding to the received light.

10. The camera module of claim 9, wherein a captured image is output by moving an image in the image sensor module or the image sensor module itself by a positional change of an optical axis according to AF driving of the light-refracting AF module.

11. The camera module of claim 10, wherein in a case of moving the image in the image sensor module, a pixel movement amount in the image sensor module is calculated based on a signal for AF driving of the light-refracting AF module, and the image is moved and displayed according to the pixel movement amount, thereby canceling a movement amount of a screen due to the AF driving of the light-refracting AF module.

12. The camera module of claim 10, wherein in a case of moving the image sensor module itself, a movement amount of the image sensor module is calculated based on a signal for AF driving of the light-refracting AF module, and by moving the image sensor module, a movement amount of a focus of a subject due to the AF driving of the light-refracting AF module is canceled.
